(19) United States
(12) Patent Application Publication
(10) Pub. No.: US 2026/0256107 A1
(43) Pub. Date: Sep. 3, 2026

(54) POSITIVE-PRESSURE SYSTEMS AND METHODS FOR ANIMAL COOLING AND/OR BUILDING VENTILATION

(71) Applicant: Wisconsin Alumni Research Foundation, Madison, WI (US)

(72) Inventors: Kenneth Nordlund, Madison, WI (US); Christopher Choi, Madison, WI (US)

(21) Appl. No.: 19/178,140

(22) Filed: Apr. 14, 2025

Related U.S. Application Data
(60) Provisional application No. 63/633,156, filed on Apr. 12, 2024.

(51) Int. Cl. A01K 1/00

(52) U.S. Cl. CPC A01K 1/0052; A01K 1/0058; A01K 1/0064

(57) ABSTRACT

A positive pressure plenum for a cooling and/or ventilation system, wherein the plenum has at least two distribution tubes and at least one fan coupled thereto. In some embodiments, the plenum is modular and has at least two coupleable modular sections. Other embodiments include a cooling and/or ventilation system for an animal building that has at least one modular plenum, at least two distribution tubes extending through a bottom wall of the plenum, and at least one fan, wherein the bottom wall is disposed at a predetermined distance above a floor of the building. Further implementations include such systems that can be modified to deliver a desired airflow velocity to specific heights above the building floor to ensure optimal cooling of the animals therein.

### CROSS-REFERENCE TO RELATED APPLICATION(S)

This application claims the benefit under 35 U.S.C. § 119(e) to U.S. Provisional Application 63/633,156, filed Apr. 12, 2024 and entitled “Positive-Pressure Systems and Methods for Animal Cooling and/or Building Ventilation,” which is hereby incorporated herein by reference in its entirety.

### FIELD

The various embodiments herein relate to building cooling and ventilation systems, including such cooling and ventilation system for animal buildings such as barns.

### BACKGROUND

The cooling of animals and ventilation of animal buildings such as barns is critical to animal health and productivity. For example, heat stress impacts cow health and subsequently milk production. Further, as the size of dairy herds increases due to consolidation, the problem grows exponentially as more cows are confined to larger barns.

Known ventilation systems for cooling cows in dairy barns (and for cooling other animals in other buildings such as hog confinement buildings, for example) create negative pressure inside the barn by exhausting sufficient air through one wall with large exhaust fans and admitting fresh air from the opposite wall via air intake vents to create a cooling horizontal airflow that passes from the intake vents to the fans, in some cases at cooling speeds of more than 200 ft/minute. All of these systems involve horizontal air flow side to side across the width of the barn (cross ventilation) or end to end across the length of the barn (tunnel ventilation). In many cases, these ventilation systems are combined with water sprinklers to wet the cow skin such that the air flow helps to reduce the negative effects of heat stress on cow milk yield, reproductive performance, and health.

These cooling and/or ventilation systems have several disadvantages. For example, one disadvantage is that the horizontal airflow results in uneven air speeds in various locations within the barn, thereby resulting in uneven cooling of the cows or other animals. This is caused by the various objects within the barn, including waterers, walls, stalls, and the cows themselves, all of which deflect the air stream toward open feed lanes or other areas away from the cows, reducing air flow speeds on the cows and in the stalls. Another disadvantage is the cost of the electrical power required not only for the exhaust fans, but also for additional interior recirculating fans that are sometimes installed to create more consistent air flow. As a result, the electrical power costs often consume more than ⅓ of the entire dairy electricity expenditures for a barn.

A further disadvantage of the known cooling/ventilation systems is increasing temperature and poor air quality as the air flows through the barn. More specifically, because air is pulled into the barn on one side and move across the entire length or width of the barn, the air increases in temperature and gains particulate matter and microorganisms as it travels, thereby reducing the cooling effect and presenting a potential respiratory disease challenge for the animals inside. In addition, a related disadvantage is the increased fan maintenance resulting from the poor quality of the air as it passes through. That is, because the exhaust fans are pulling moist air full of particulates therethrough, the fans become very dirty and fan cleaning and maintenance presents a significant demand for labor. Another related disadvantage is the extremely cold temperatures near the air intake vents in the winter. Because all air enters on one side of the barn, the inlet locations become extremely cold in winter, which can have negative effects on the cows and can also create increased risk of falling injuries to the cows as a result of slippery areas of ice and frozen manure.

Yet another disadvantage of the known cooling/ventilation systems is the air flow disruption that occurs when any door to the barn is open. Because the barn interior is under negative pressure caused by the ventilation system, any door opening for entrance of feeding, manure handling, or bedding equipment becomes a major air inlet, thereby disrupting the intended airflow in other areas of the barn while the doors are open. In other words, in large dairy barns, large doors need to be opened many times each day for such equipment, which thereby “short-circuits” the planned airflow.

There is a need in the art for improved cooling and/or ventilation systems for dairy barns and any other animal buildings.

### BRIEF SUMMARY

Discussed herein are various improved systems for cooling animals and/or ventilation of animal buildings, including systems having a modular plenum for positive pressure cooling with at least two coupleable modular sections and at least one fan.

In Example 1, a modular plenum for a positive pressure cooling and/or ventilation system comprises a bottom wall, a top wall, two side walls, and two end walls defining an interior within the plenum, at least two distribution tubes extending through the bottom wall from the interior to an area exterior to the plenum, and at least one fan disposed in at least one of the end walls, wherein the at least one fan is configured to urge air into the interior of the plenum, wherein the modular plenum further comprises at least two modular sections that are coupleable with each other to form the modular plenum.

Example 2 relates to the plenum according to Example 1, wherein the at least one fan is further configured to urge air out of the interior of the plenum through the at least two distribution tubes.

Example 3 relates to the plenum according to Example 1, wherein the at least two modular sections comprise a first modular section comprising at least one of the at least two distribution tubes and a second modular section comprising at least one of the at least two distribution tubes.

Example 4 relates to the plenum according to Example 1, wherein a distal end of each of the at least two distribution tubes is disposed about 10 feet above a floor below the modular plenum.

Example 5 relates to the plenum according to Example 1, wherein air is urged out of the interior of the plenum through each of the at least two distribution tubes such that the air has a velocity of about 400 feet per minute at a location disposed about 5.7 feet above a floor below the modular plenum.

Example 6 relates to the plenum according to Example 5, wherein air is urged out of the interior of the plenum through each of the at least two distribution tubes such that the air has a velocity of about 200 feet per minute at a location disposed about 1.5 to about 2 feet above the floor.

In Example 7, a modular plenum for a cooling and/or ventilation system for an animal building comprises an elongate plenum body made up of at least two coupleable sections, the elongate plenum body comprising a bottom wall, a top wall, two side walls, and two end walls defining an interior within the elongate plenum body and at least two distribution tubes extending through the bottom wall from the interior to an area exterior to the plenum body. The plenum further comprises at least one fan disposed in at least one of the end walls, wherein the at least one fan is configured to urge air into the interior of the elongate plenum body.

Example 8 relates to the plenum according to Example 7, wherein the elongate plenum body is disposed beneath a roof of the animal building such that the bottom wall is disposed at a predetermined distance above a floor of the animal building.

Example 9 relates to the plenum according to Example 7, wherein the elongate plenum body is disposed above a ceiling of the animal building, wherein the at least two distribution tubes extend through the ceiling such that a distal end of each of the at least two distribution tubes is disposed below the ceiling.

Example 10 relates to the plenum according to Example 7, wherein a distal end of each of the at least two distribution tubes is disposed about 10 feet above a floor of the animal building.

Example 11 relates to the plenum according to Example 7, wherein air is urged through each of the at least two distribution tubes such that the air has a velocity of about 400 feet per minute at a location disposed about 5.7 feet above a floor of the animal building.

Example 12 relates to the plenum according to Example 11, wherein air is urged through each of the at least two distribution tubes such that the air has a velocity of about 200 feet per minute at a location disposed about 1.5 to about 2 feet above the floor of the animal building.

In Example 13, a cooling and/or ventilation system for an animal building comprises at least one elongate modular plenum body made up of at least two coupleable sections, the elongate modular plenum body comprising a bottom wall, a top wall, two side walls, and two end walls defining an interior within the elongate modular plenum body, at least two distribution tubes extending through the bottom wall of the at least one elongate modular plenum body from the interior to an area exterior to the plenum body, and at least one fan disposed in at least one of the end walls of the at least one elongate modular plenum body, wherein the at least one elongate modular plenum body is disposed beneath a roof of the animal building such that the bottom wall is disposed at a predetermined distance above a floor of the animal building.

Example 14 relates to the system according to Example 13, wherein the elongate plenum body is disposed above a ceiling of the animal building, wherein the at least two distribution tubes extend through the ceiling such that a distal end of each of the at least two distribution tubes is disposed below the ceiling.

Example 15 relates to the system according to Example 13, wherein the bottom wall has greater rigidity than the two side walls.

Example 16 relates to the system according to Example 13, wherein the at least two distribution tubes are disposed solely over the animal living spaces of the animal building.

Example 17 relates to the system according to Example 13, wherein the at least one fan comprises a first fan disposed in a first of the two end walls and a second fan disposed in a second of the two end walls.

Example 18 relates to the system according to Example 13, wherein air is urged through each of the at least two distribution tubes such that the air has a velocity of about 400 feet per minute at a location disposed about 5.7 feet above a floor of the animal building.

Example 19 relates to the system according to Example 13, wherein a length of the elongate modular plenum body is substantially parallel to a length of the animal building, wherein the at least one fan is disposed at an end of the animal building.

Example 20 relates to the system according to Example 13, wherein a length of the elongate modular plenum body is substantially parallel to a width of the animal building, wherein the at least one fan is disposed along a side of the animal building.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1A is a perspective end view of a robot milking barn with a pressurized cooling and/or ventilation system, according to one embodiment.

FIG. 1B is a perspective end view of a head-to-head freestall barn with a pressurized cooling and/or ventilation system, according to one embodiment.

FIG. 10 is a perspective end view of a traditional tie-stall barn with a pressurized cooling and/or ventilation system, according to one embodiment.

FIG. 2 is a perspective view of an exemplary plenum, according to one embodiment.

FIG. 3 is a schematic view of air streams from distribution tubes of a plenum, according to one embodiment.

FIG. 4A is a perspective end view of a robot milking barn with a pressurized cooling and/or ventilation system, according to one embodiment.

FIG. 4B is a perspective view of a portion of the interior of the robot milking barn and cooling and/or ventilation system of FIG. 4A, according to one embodiment.

FIG. 4C is a perspective view of another portion of the interior of the robot milking barn and cooling and/or ventilation system of FIG. 4A, according to one embodiment.

FIG. 4D is a perspective view of yet another portion of the interior of the robot milking barn and cooling and/or ventilation system of FIG. 4A, according to one embodiment.

FIG. 4E is a perspective view of an interior of a plenum of the cooling and/or ventilation system of FIG. 4A, according to one embodiment.

FIG. 4F is another perspective end view of the robot milking barn with the pressurized cooling and/or ventilation system of FIG. 4A, according to one embodiment.

FIG. 4G is yet another perspective end view of the robot milking barn with the pressurized cooling and/or ventilation system, according to one embodiment.

FIG. 5A is a perspective end view of a head-to-head freestall barn with a pressurized cooling and/or ventilation system, according to one embodiment.

FIG. 5B is another perspective end view of the head-to-head freestall barn with the pressurized cooling and/or ventilation system of FIG. 5A, according to one embodiment.

FIG. 5C is yet another perspective end view of the head-to-head freestall barn with the pressurized cooling and/or ventilation system of FIG. 5A, according to one embodiment.

FIG. 5D is another perspective end view of a portion of the head-to-head freestall barn with the pressurized cooling and/or ventilation system of FIG. 5A, according to one embodiment.

FIG. 5B is another perspective end view of another portion of the head-to-head freestall barn with the pressurized cooling and/or ventilation system of FIG. 5A, according to one embodiment.

FIG. 6A is a perspective end view of a traditional tie-stall barn with a pressurized cooling and/or ventilation system, according to one embodiment.

FIG. 6B is a perspective view of two plenums of the pressurized cooling and/or ventilation system in the traditional tie-stall barn of FIG. 6A, according to one embodiment.

FIG. 6C is a perspective view of a portion of the interior of the traditional tie-stall barn with the pressurized cooling and/or ventilation system of FIG. 6A, according to one embodiment.

FIG. 6D is another perspective end view of the traditional tie-stall barn with the pressurized cooling and/or ventilation system of FIG. 6A, according to one embodiment.

FIG. 7A is a perspective end view of another barn with a pressurized cooling and/or ventilation system, according to one embodiment.

FIG. 7B is a perspective view of a portion of the interior of the barn with the pressurized cooling and/or ventilation system of FIG. 7A, according to one embodiment.

FIG. 7C is a perspective view of an interior of a plenum of the cooling and/or ventilation system of FIG. 7A, according to one embodiment.

FIG. 8A is a perspective end view of another barn with a pressurized cooling and/or ventilation system, according to one embodiment.

FIG. 8B is a perspective view of a side of the barn with the pressurized cooling and/or ventilation system of FIG. 8A, according to one embodiment.

FIG. 9 is a perspective end view of a plenum of a pressurized cooling and/or ventilation system, according to one embodiment.

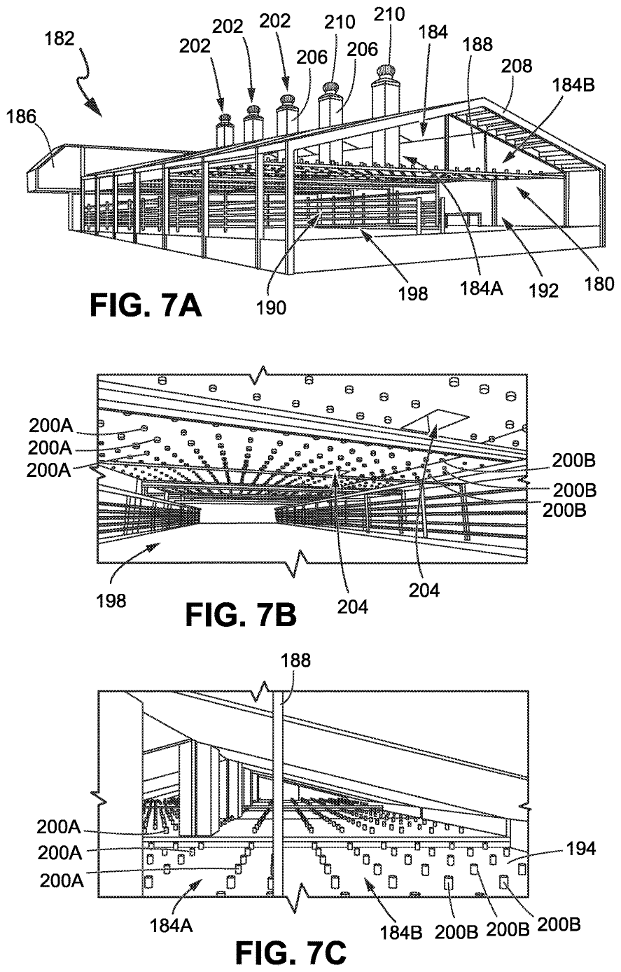

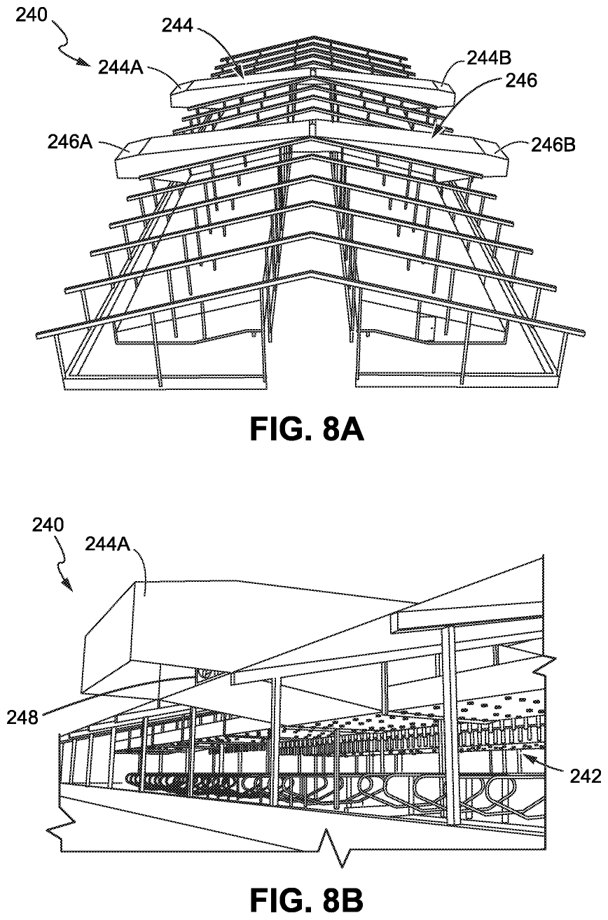

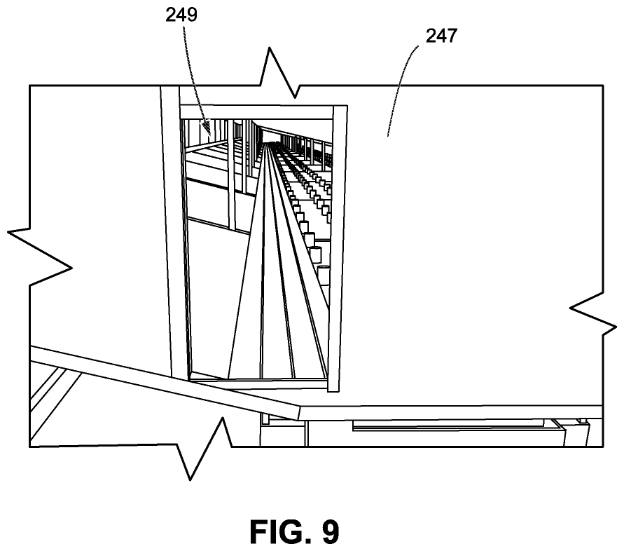

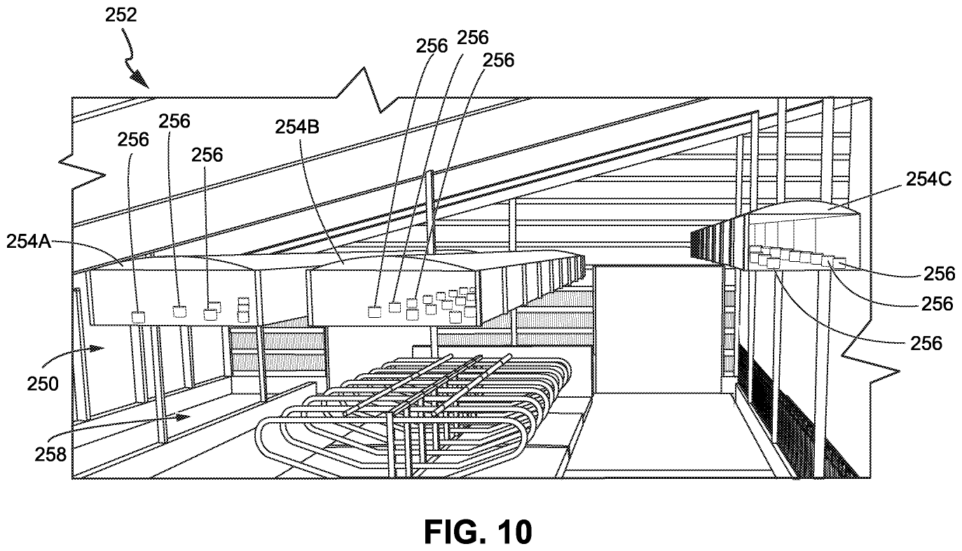

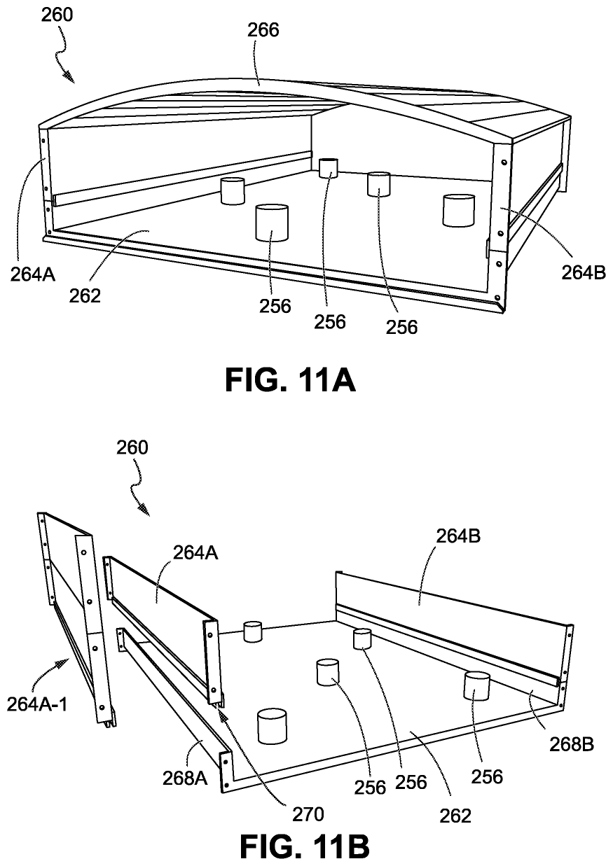

FIG. 10 is a perspective view of modular pressurized cooling and/or ventilation plenums disposed in a barn, according to one embodiment.

FIG. 11A is a perspective view of one section of one of the modular plenums of FIG. 10, according to one embodiment.

FIG. 11B is a perspective exploded view of certain components of the section of FIG. 11A, according to one embodiment.

### DETAILED DESCRIPTION

Disclosed herein are positive-pressure cooling and ventilation systems that provide substantially vertical air streams for cooling animals in buildings, including cooling dairy cows in dairy barns. Certain system embodiments provide both cooling and ventilation. That is, such embodiments are configured not only to cool the animals with vertical air streams of specific velocities in warm weather, but also to provide ventilation to the building in mild and/or colder weather via lower velocity air streams.

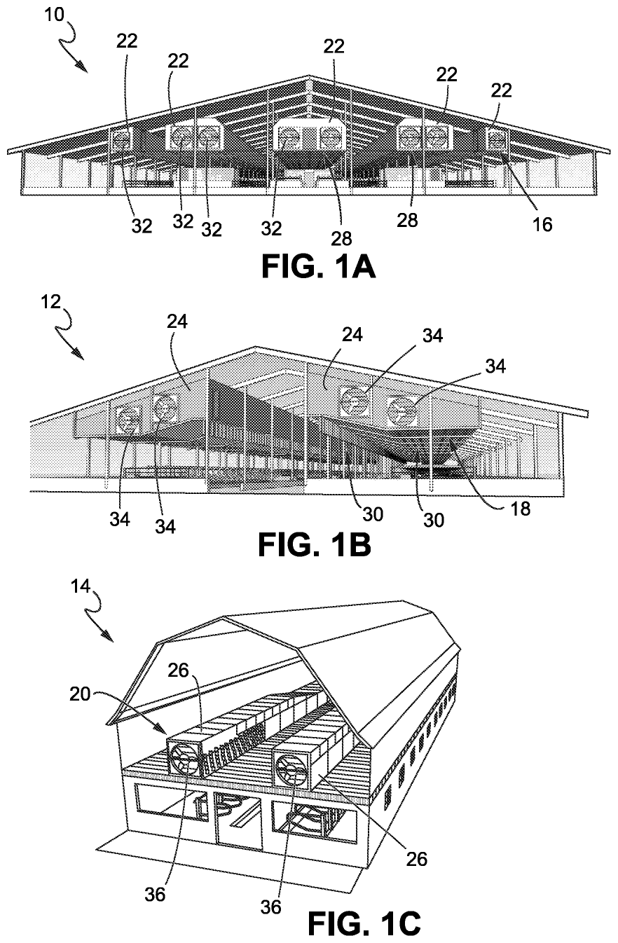

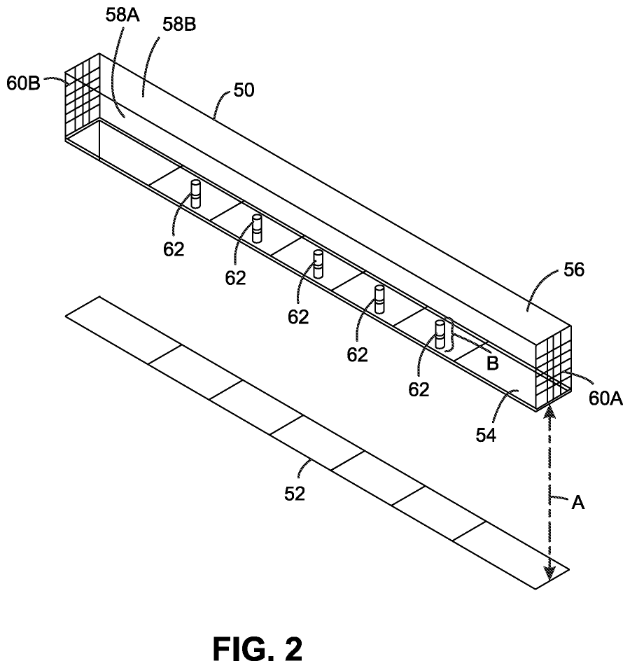

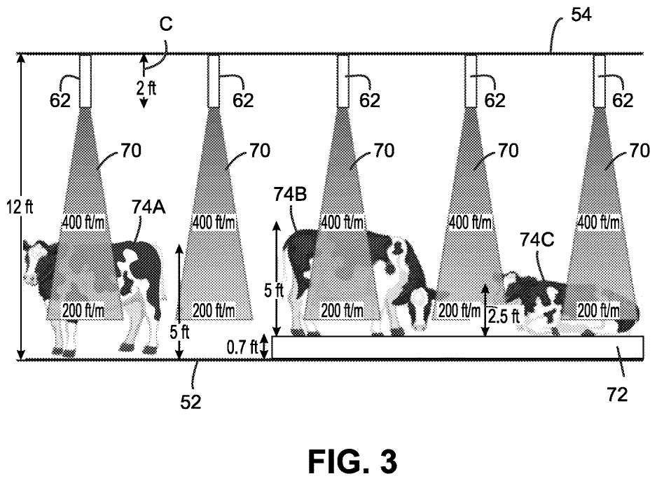

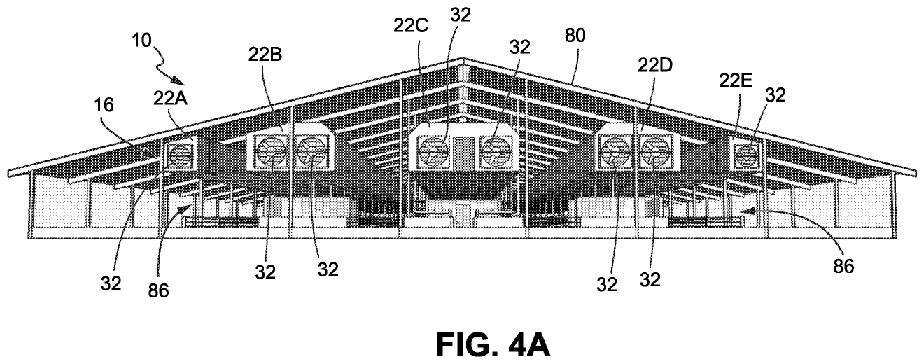

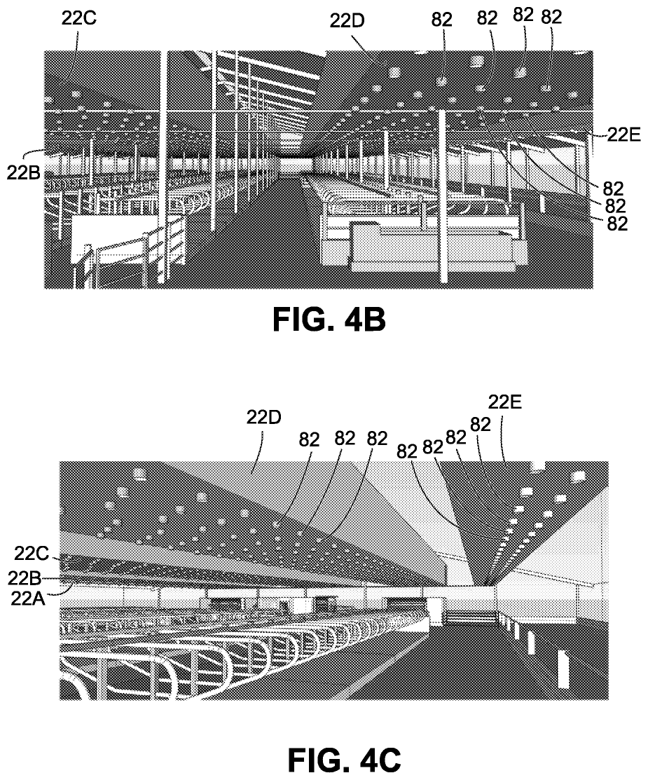

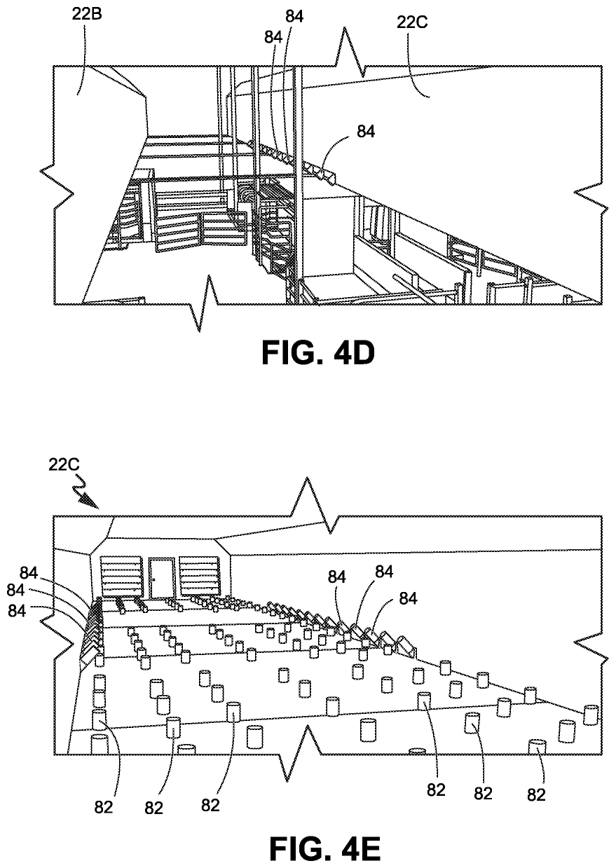

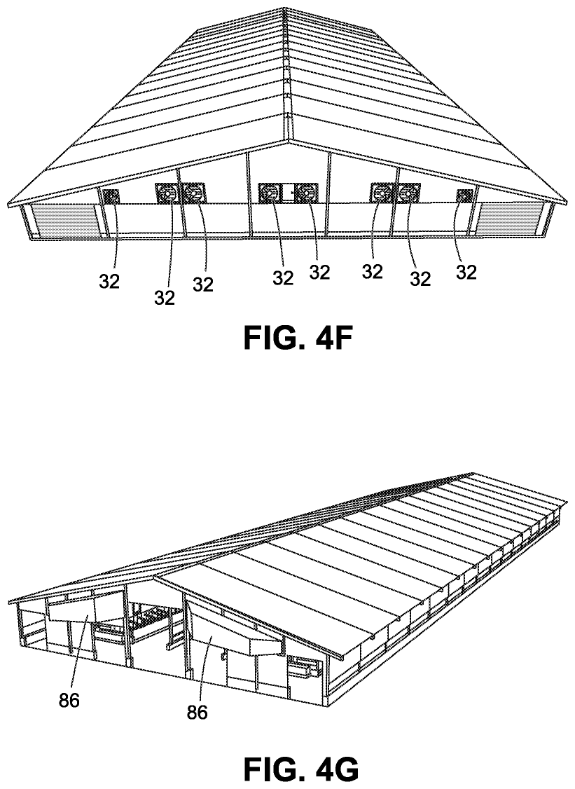

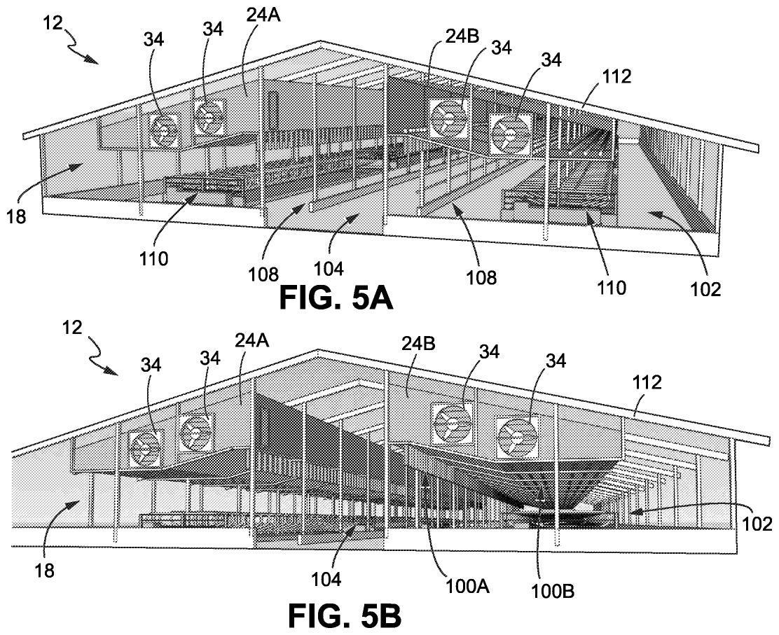

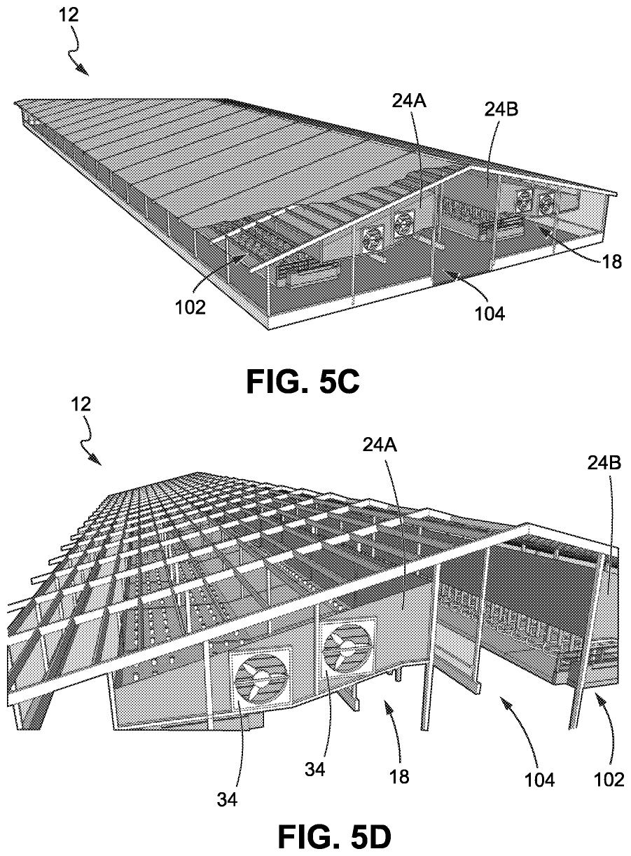

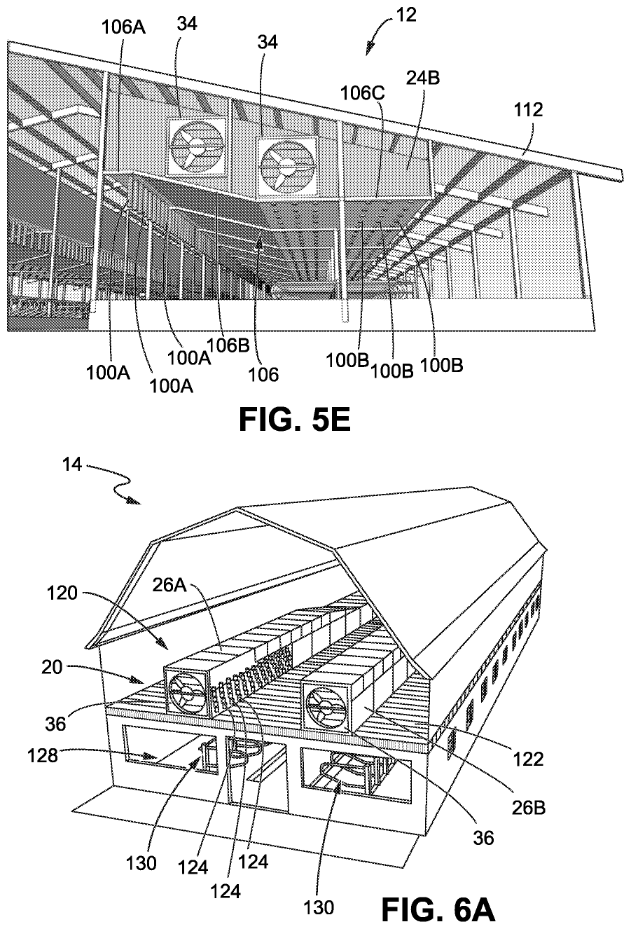

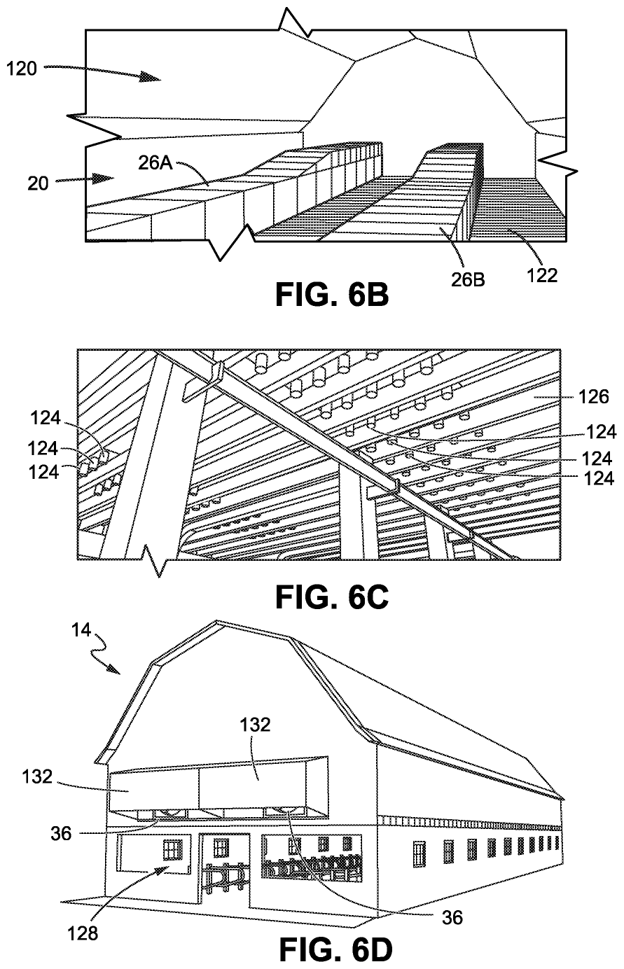

Exemplary pressurized cooling systems 16, 18, 20 are depicted in various barn types in FIGS. 1A-1C, according to certain embodiments. More specifically, the cooling system 16 is disposed within a robot milking barn 10, the cooling system 18 is disposed within a four-row head-to-head freestall barn 12, and the cooling system 20 is disposed within a traditional tie-stall barn 14 with a high open haymow. Thus, the various cooling system embodiments herein can be incorporated into a wide variety of building types that are not limited to the exemplary barn types in FIGS. 1A-1C, and further can be incorporated into new building construction or retrofitted into existing buildings.

As will be described in further detail below, each of the specific systems 16, 18, 20 as shown in FIGS. 1A-1C is a modular system having at least one elongate pressurizable plenum 22, 24, 26 that is disposed within a space above the stalls and/or feeding areas of the barn. Elongate tubes (or “nozzles”) 28, 30 (not visible in FIG. 1C) extend out of the bottom of the plenum 22, 24, 26 such that each tube 28, 30 can deliver an air stream (also referred to herein as an “air jet”) from above to the area below the tube 28, 30 and thereby spread throughout common areas. Each pressurized plenum 22, 24, 26 is pressurized via at least one fan 32, 34, 36 disposed at at least one end of the plenum 22, 24, 26 such that the fan 32, 34, 36 blows external, fresh air into the plenum 22, 24, 26. Each system 16, 18, 20 delivers air speeds from each tube 28, 30 that can cool the animals within the barn 10, 12, 14 regardless of the animal's location or whether the animal is standing or laying in its stall. After the pressurized air is delivered into the living space of the barn 10, 12, 14, the air is exhausted through normal open areas of the barn 10, 12, 14, thereby venting the contaminated air to the outside rather than circulating it inside. As such, the various cooling system embodiments herein can provide better air quality while cooling the animals while using far less energy than known ventilation systems as a result of requiring few fans to achieve the desired air pressure and air flow speeds.

A simplified exemplary plenum 50 that can be incorporated into any of the various cooling system embodiments disclosed or contemplated herein is depicted in FIG. 2, according to one implementation. The plenum 50 is an elongate body 50 having a bottom wall 54, a top wall 56, two side walls 58A, 58B, and two end walls 60A, 60B and is positioned at a desired distance A (or the distance A allowed by the configuration of the barn) above the floor 52 of the animal living space. While the specific exemplary plenum 50 as shown has a substantially square cross-section (viewing the body 50 along its length), the various plenum 50 embodiments as disclosed and contemplated herein (and some specific implementations as described in further detail below) can take on any number of configurations as needed depending on the size and configuration of the barn in which it is disposed. The plenum 50 has at least one fan (not shown) disposed in or otherwise attached to at least one of the two end walls 60A, 60B to create the desired pressurized environment within the plenum 50. In certain embodiments, both end walls 60A, 60B have at least one fan (not shown) therein. Disposed through and extending out of the bottom wall 54 of the plenum 50 are multiple elongate air distribution tubes (or “nozzles”) 62 through which the pressurized air is urged downward toward the floor 52 of the animal living space. Thus, the at least one fan (not shown) positioned in at least one of the end walls 60A, 60B can be actuated at the desired speed to create the desired air pressure within the plenum 50 such that the air is urged through and out of each of the distribution tubes 62 in a downward vertical direction at the desired velocity as discussed in additional detail below.

In the exemplary plenum 50 as shown, there are five air distribution tubes 62, each of which generates one of the cooling air streams that is directed down into the animal living space. As will be described in additional detail below and in any of the various embodiments herein, there can be any number of distribution tubes 62 depending on the size of the plenum 50, the size of the barn and/or animal living space, the configuration of the barn, the desired number of cooling air streams, and various other factors. Further, the distribution tubes 62 can be distributed anywhere in the bottom wall 54 of the plenum 50 in any configuration and/or pattern. In certain implementations, the distribution tubes 62 can be PVC pipes 62. Alternatively, the distribution tubes 62 can be any tubes made of any known substantially rigid material for use in such cooling systems. As set forth herein, any of the various system implementations disclosed or contemplated herein will have a number of tubes (such as distribution tubes 62 as discussed herein). The tubes will be interchangeably referred to as nozzles, elongate tubes, distribution tubes, or the like, such that any of the tubes (such as tubes 62 or any other nozzle or tube embodiments herein) can have any of the structural characteristics or features of any specific tube embodiment detailed herein. Generally, every tube (such as distribution tube 62) will have an elongate tubular body associate with a plenum and having a lumen defined therethrough such that the tube can direct an air stream out of the tube and toward the living space in the barn as discussed in further detail in the various implementations herein.

According to some embodiments, the distribution tubes 62 are disposed through and attached to the bottom wall 54 such that a predetermined length (represented by arrow B) of each tube 62 extends upward some distance above the bottom wall 54 as shown. In one embodiment, the vertical length B of each tube 62 is at least about 8 inches. Alternatively, the vertical length B above the bottom wall 54 can be any length that ensures that the top opening of each tube 62 is disposed above any insulation within the plenum 50 to avoid the insulation entering the tube 62 and obstructing the airflow therethrough. In certain implementations, a flange (not shown) is disposed around each tube 62 at the desired location along the length of the tube 62 such that the flange makes contact with or is otherwise attached to the bottom wall 54 and results in the predetermined length B disposed above the bottom wall 54 while allowing the tube 62 to be disposed through but unattached to the bottom wall 54. Alternatively, the tubes 62 can be removably disposed on or attached to the bottom wall 54 via any known mechanism or method. In one embodiment, the tube 62 can have an internal diameter of about 3 inches, 3.5 inches, 4 inches, 5 inches, or 6 inches, depending on the desired air stream velocity, the air pressure in the plenum 50 and other such parameters as discussed elsewhere herein. Alternatively, the tube 62 can have an internal diameter ranging from about 0.25 inches to about 12 inches. In a further alternative, the tube 62 can have an internal diameter ranging from about 3 inches to about 9 inches. In yet another alternative, the tube 62 can have any desired internal diameter as needed depending on the other parameters (such as air stream velocity, air pressure in the plenum, tube angle, distance between the tubes, plenum size, etc.).

In accordance with certain exemplary implementations, a cooling and/or ventilation system made up of prefabricated modular components is provided for efficient, standardized incorporation into any animal building. For example, one embodiment relates to a set of modular, prefabricated plenums (similar to plenum 50, for example, or any other plenum disclosed or contemplated herein) of predetermined sizes such that the plenum of the correct size can be selected for any specific target building. More specifically, in one example, the system can have three or more different modular plenums of predetermined sizes (such as, for example, small, medium, and large sizes) such that, once the target building has been identified and the dimensions of that building determined, the correctly sized modular plenum amongst the differently-sized options can be selected and the modular components thereof can then be incorporated into the building. In one embodiment, the system has two modular plenums of two different sizes. Alternatively, the system can have three, four, five, six, seven, eight, nine, ten, or any number of modular plenums of different, predetermined sizes to choose from.

As shown in FIG. 3 according to one embodiment, the distribution tubes 62 can extend downward some predetermined length C from the bottom wall 54 such that the distal ends of the tubes 62 are disposed at a predetermined height above the floor 52 of the animal living space and thus are also disposed at a predetermined height above the animals (such as cows). In such embodiments, the disposition of the tubes 62 can also allow for the presence of freestall beds 72 (such as the bed 72 as shown) that have a surface disposed from about 4 inches to about 10 inches above the surface of the floor 52. For certain implementations, the desired airstream velocity to ensure effective cooling of the animals is about 400 feet per minute (“ft/min”) at a height of about 5.7 feet above the floor 52 and about 200 ft/min at a height of about 1.5 feet to about 2 feet above the floor 52. These targets have been set based on studies showing that these air stream velocities provide the optimal amount of cooling for the animal in the air stream. Velocities higher than these targets generally add only marginal additional cooling benefit. Thus, according to one embodiment with those target velocities and based on the average height of a cow, as shown in FIG. 3, the air streams strike a standing cow 74A at about 400 ft/min and strike a cow that is lying down 74C at about 200 ft/min. Alternatively, there is nothing limiting the various embodiments herein to any specific air stream velocities—any air stream velocity that provides a desired amount of cooling to the animals in the living space can be used.

In the exemplary embodiment of FIG. 3, the barn has a 12-foot ceiling height and freestall beds 72 as discussed above that are elevated by 0.7 ft above the barn floor 52 such that the ceiling 54 is 11.3 feet above the freestall beds 72. Given these dimensions, the net distance between the ceiling 54 and a cow 74A standing in the feeding/watering areas is about 7 feet, while the net distance between the ceiling and a cow 74B standing in the freestall area is about 6.3 feet, and the net distance between the ceiling and the cow lying in the freestall area is about 8.8 feet. In this embodiment, the target airstream velocities described above are achieved by positioning the distal ends of the tubes 62 at a height of 10 feet above the floor 52 such that the tube length C from the bottom wall 54 in this specific embodiment is 2 feet. Of course, this height depends on a number of different parameters, including the air pressure in the plenum 50, the inner diameter of the tubes 62, and other such parameters. These velocities were identified and achieved based on calculations and parameters set forth below in the Examples. Alternatively, the air stream velocity that strikes a standing cow can range from about 200 ft/min to about 500 ft/min, while the air stream velocity that strikes a cow that is lying down can range from about 100 ft/min to about 500 ft/min. In a further alternative, the air stream velocity that strikes a cow at either height—or any height—can be at least 200 ft/min. In yet another alternative as mentioned above, there is nothing limiting the various embodiments herein to any specific air stream velocities—any air stream velocity that provides a desired amount of cooling or ventilation to the animals in the living space can be used.

Given the goal of providing a desired number of vertical air streams with sufficient velocity to cool the animals in the animal space below, and given the number of adjustable parameters relating to the cooling system (including fan size, fan speed, plenum shape, plenum size, distribution tube diameter, tube distal end distance from floor, and airstream velocity), the various parameters can be adjusted in controlled fashion to achieve airstreams of the desired velocities. The greater the fan speed and/or size of the fan(s), the greater the pressure in the plenum and thus the greater the velocity of the air streams. The smaller the number of distribution tubes and/or the smaller the diameter of each tube, the greater the velocity of the air streams. And the longer the distribution tubes (and thus the smaller the distance between the distal end of the tubes and the barn floor), the greater the velocity of the air streams at the target animal heights.

In the various embodiments disclosed or contemplated herein, as mentioned above, the target air stream velocity from each tube 62 can be determined based on the height of the distal end of the tube 62 above the floor 52 (assuming all other parameters remain the same). For example, in the embodiment above, to achieve an air stream velocity of 400 ft/min at about 5.7 feet above the floor 52 and 200 ft/min at about 1.5 to 2 feet above the floor 52, the distal end of each tube 62 is disposed at 10 feet above the floor 52. As such, given the variability of ceiling height in various barns (and the variability of height in a ceiling of a single barn in some cases), the predetermined length C of the tubes 62 from the bottom wall 54 in a particular barn is calculated based on the ceiling height of that barn to ensure that the distal ends of the tubes 62 are disposed at the desired height (such as 10 feet) above the floor 52. Thus, while the predetermined length C in the embodiment of FIG. 3 is 2 feet, the predetermined length C in a barn with a 11 foot ceiling would be 1 ft. In addition, in a barn with a 10 foot ceiling, the length C would be 0 (the tubes 62 would not extend beyond the bottom wall 54). Further, the length C in a barn with a 13 foot ceiling would be 3 ft, the length C with a 14 foot ceiling would be 4 ft, etc.

In certain embodiments, the distribution tubes 62 can be adjustable in relation to the bottom wall 54. That is, each tube 62 can be adjusted such that the predetermined length C of the tube 62 from the bottom wall 54 can be altered as desired. For example, in certain implementations, each tube 62 can be slidable in relation to its flange (as discussed above) or a similar housing and fixed at different heights using pins or other known mechanisms or methods. Such positional adjustments of each tube 62 can result in significant changes in the air stream velocity at the target heights. According to some implementations, all of the tubes 62 in a particular barn can be adjusted to a particular height for a particular season. For example, the tubes 62 could be raised in the winter such that the predetermined length C of each tube 62 in relation to the bottom wall 54 is reduced, thereby reducing the air stream velocity such that the system provides ventilation instead of cooling.

According to certain embodiments, the plenum 50 can be modular. That is, the plenum 50 can be made of two or more separable, connectable sections such that the separate sections can be used to create a configurable plenum 50 of the desired size and length with distribution tubes of the correct diameter and length depending on the specific dimensions of the barn. This modularity makes it easier to purchase and install such a plenum 50 by simply selecting the appropriate number of separate modules based on the size and configuration of the target barn and constructing the plenum 50 of those modules and installing the resulting plenum 50 in the barn. As a result, any person or company building or installing any modular system embodiment herein knows the correct size and layout of the plenum (orthe modules thereof), based on the appropriate calculations as set forth herein. Thus, the person or company simply purchases the correct number of modular plenum units with the correct size, length and number of distribution tubes and installs them in the correct locations.

In accordance with some embodiments, the walls of the plenum 50—and any plenum embodiment disclosed or contemplated herein, including any modular plenum—can be made of fiberglass. Alternatively, the plenum 50 walls can be made of any substantially rigid lightweight material, including, for example, styrofoam or any other lightweight polymeric or composite material that is substantially rigid. In further alternatives, the bottom wall (such as bottom wall 54) can be made of fiberglass or another lightweight rigid material while the side walls, top wall, and end walls are made of a less rigid or flexible lightweight material, such as polyethylene, vinyl, or any other similar material.

In some implementations, any plenum embodiment herein (including plenum 50) can be insulated between the plenum and the animal living space below. More specifically, loose insulation, insulation sheets, or any other type of insulation having an appropriate R-value can be disposed on the bottom wall of the plenum or between the bottom wall of the plenum and the ceiling above the animal living space. Such insulation can minimize or prevent condensation on the ceiling of the animal living space as a result of the air in the plenum being colder than the animal room below, which, in some locations, can reach a different of as much as 40-50° F.

In various implementations, the plenum 50 (and each plenum embodiment disclosed or contemplated herein) is disposed above the animal living space in the barn such that the tubes 62 can direct the cooling airstreams downward directly onto the animals therein. In those barns having an existing ceiling, the plenum 50 is placed above the ceiling such that the bottom wall 54 of the plenum 50 is positioned on the ceiling and thus has a distance from the barn floor that is substantially the same as the ceiling itself. Thus, for purposes of the various embodiments herein in which the barn has a ceiling and the plenum 50 is disposed thereon, the ceiling and the bottom wall 54 can be treated as the same structure or at least as having the same distance from the barn floor. Alternatively, in those embodiments in which there is no attic or haymow, the plenum 50 can be hung within the barn such that bottom wall 54 constitutes the ceiling (or a partial ceiling) of the barn. Specific barn embodiments with different ceiling configurations (some with ceilings and others without) are described in detail below.

Alternatively, instead of a plenum, in some implementations in which the barn has a haymow or attic separated from the animal living space by the living space ceiling, the entire attic or haymow can be pressurized such that the entire space operates in a fashion substantially similar to any plenum embodiment as discussed herein. Certain exemplary embodiments will be discussed in additional detail below. In such implementations, the pressurizable space is configured to have an interior that is substantially fluidically sealed from the exterior of the space such that the pressurized air cannot escape except through the distribution tubes. For example, in some implementations, an airtight flexible material may be added to the interior of the walls of the pressurizable space to create the airtight seal therein. Alternatively, instead of an additional airtight lining, construction of the walls of the pressurizable space within the barn is tighter than typical barn construction so that there is little or no substantial air leakage from the space. In a further alternative, a sealant or other barrier (such as the exemplary sealants or barriers available from www.aeroseal.com/aerobarrier and/or www.wrmeadows.com/air-barriers) can be used to plug or otherwise seal off air leaks after construction. Aside from the lining, tighter construction, and/or sealants/barriers, such pressurizable space embodiments have substantially the same components and/or features that operate in substantially the same fashion as any plenum embodiment herein, including the fans, the distribution tubes, the optional insulation, etc.

In certain embodiments, the plenum 50 (or pressurizable attic) is configured to extend over the entire animal compartment, including the holding pens, feedlines, etc. Alternatively, as will be discussed in further detail in an exemplary embodiment below, in barns that feature drive-through feed or cleaning lanes or the like, the one or more plenums (or attics) can be positioned such that they are not disposed over those lanes, thereby allowing for such drive-through lanes to have higher clearance for feed trucks or other vehicles or equipment to pass through. In further alternatives, the plenum 50 or pressurizable attic can be disposed over any or all portions of the animal compartment as desired.

As will be discussed in additional detail below, while the exemplary systems as shown in FIGS. 1A-1C and discussed above depict at least one fan at at least one end of the various barns depicted therein, alternative system embodiments can instead (or in addition) have fans disposed on one or both of the sides of the barn. In such embodiments, the barn can have one or more plenums that are disposed across the width of barn instead of (or in addition to) the length thereof such that the fan or fans are disposed on the side(s) of the barn, or alternatively can have one or more fluidically sealed pressurizable attics or haymows with fan(s) disposed on the side(s) of the barn.

The one or more fans incorporated into the system embodiments herein can any variable speed fans used in building ventilation and cooling. Further implementations have one or more fans with a continuous range of speed that can be controlled based on the barn interior temperature. Additionally, according to certain embodiments, the one or more fans can function efficiently at static pressures up to 0.2″ H2O (50 Pascals). In one specific example, the one or more fans can have a minimum efficiency of 17 cfm/Watt at SP 0.2″ H2O. In further embodiments, the one or more fans can be any known fans of any type that are used for building ventilation and cooling. In certain specific embodiments, variable speed fans are used to allow for the system to be used not only for cooling, but also for basic ventilation (fresh air input). That is, in those situations in which it is desirable to reduce the velocity of the air streams from the distribution tubes such that the air streams deliver fresh air without a significant cooling effect, one or more variable speed fans can be slowed, thereby reducing the pressure within the plenum such that the air output slows to the desired level. Alternatively, as discussed elsewhere herein, the same effect can be achieved by adjusting the position of the distribution tubes (raising all of the tubes such that the distal ends of each are rather away from the target areas of the animal space below), thereby reducing the air stream velocity to a non-cooling speed.

In certain implementations, the one or more fans can also have louvers to minimize or prevent the exit of air to the exterior of the building when the one or more fans is not in use. Further, according to some embodiments, hoods or other similar structures can be constructed over each fan or, alternatively, each fan can be positioned within a recess under the roofing of the barn. Such structures or positioning of each fan can prevent rain from being blown into the plenum.

In the various cooling and ventilation systems herein, the building has air exhaust openings that allow the air from the pressurized airstreams to ultimately exit the building. That is, the air exhaust openings can be open sidewalls, open doorways, open ridges, cupolas, or the like that allow the air pushed into the animal living space via the distribution tubes to exit through such openings. In some specific implementations, including one such implementation that will be discussed in further detail below, cupolas can be incorporated into the building—such as a very wide barn, for example—to serve as air exhaust openings that minimize rain entering the building (in comparison to side openings, for example). Some exemplary cupola embodiments can have towers that extend vertically from the animal living space, through the plenum, and out of the roof of the building.

In accordance with various implementations, the positioning of the various distribution tubes 62 above the animal living space can be determined based on the behavior and activities of the animals. More specifically, the tubes 62 can be positioned above those areas where the animals are expected to spend most of their time. For example, in those barns in which the animals are spending most of their time in the stalls, feeding areas, and alleys (including around the waterers), then the distribution tubes 62 can be positioned above those areas to ensure that each animal is being supplied with cooling air from the distribution tubes most of the time that the animal is spending in the barn.

In one specific example, a study was performed in 15 barns to determine where the cows were spending their time. As set forth in Table 1 below, in 24 hours, the 205 cows spent all but 2.7 hours in the barn, splitting their time among feeding area, the alley (that includes the waterers), and the stalls. By ensuring that there are distribution tubes providing air streams downward on all those areas, it was determined that the cows were being supplied with the cooling air streams for an average of 20.15 hours out of 21.3 hours in the barn (95%) (with the other 2.7 hours being spent outside the barn for milking).

TABLE 1
Daily time budgets*

| | Mean, hr/day, | Hours under nozzles, |
|---|---|---|
| | 205 cows, 15 | positive pressure |
| Activity | herds | plenum barn |
| Milking | 2.7 | — |
| Feeding | 4.3 | 4.3 |
| Alley including drinking | 2.5 | 1.25 (other half in alleys) |
| Stall, standing | 2.7 | 2.7 |
| Stall, lying | 11.9 | 11.9 |
| Total | 24 | 20.15 of 21.3 |
| | | hr in barn (95%) |

According to certain embodiments, a method is provided for determining the specific parameters for a cooling system for a specific barn and the steps that can be taken to incorporate (or add) that system into the barn. That is, each existing barn and any new barn will have a variety of configurations and dimensions, thereby requiring different dimensions of the cooling system, including the plenum and the various other components. Further, according to some implementations, the cooling system can also be used to provide an appropriate ventilation rate (or number of air changes per hour) to prevent heat accumulation. In other words, the various system embodiments herein can be used not only for purposes of providing cooling air streams to the animals in the living space, but also to ensure that there is sufficient air exchange throughout the living space of the barn to prevent heat accumulation in the living space or in specific areas thereof. Given the tailorable nature of the various system embodiments and the modularity of the plenum components, a method as set forth below can be used to construct a cooling system that achieves the desired air stream velocities as discussed elsewhere herein while also providing sufficient ventilation to achieve the desired air exchange within the living space of the barn.

It should be noted that recommended air changes per hour (“ACH”) for summer ventilation of an animal barn by various studies and/or experts vary from 30 to 100 ACH. However, it is believed that this wide range results in part from some of the higher rate recommendations incorporating cooling air speed requirements as well, rather than focusing solely on preventing heat accumulation. Thus, it is believed that the recommended ACH rates at the lower end of the range can reasonably be used to maintain sufficient summer ventilation.

According to one embodiment, the method for setting up a cooling and ventilation system that meets target ACH rates while also ensuring sufficient cooling of the animals can include the following steps.

In this implementation, the first step is to determine the areas of the barn where cooling air jets for the animals below will be provided. According to one embodiment as described in additional detail elsewhere, the priority locations for the tubes can be the stall resting areas, the feedlines, and the water areas, with other areas being a lower priority. Alternatively, the distribution tubes can be positioned within the barn in any configuration that provides the desired amount of cooling for the animals therein.

The second step, according to this exemplary embodiment, is to arrange the nozzles in an appropriate pattern over the area to be cooled. For example, the nozzles might be located such that there are three nozzles over each cow stall. Alternatively, they might be placed on a grid of squares, each 3 feet apart, over an entire holding pen where cows stand awaiting milking. Any other pattern is contemplated as well.

In the third step, a nozzle is selected that will deliver the target air velocity to cool the animals appropriately. Assuming some static pressure within the plenum above, both the nozzle diameter and the height of the nozzle tip above the animals can be modified to achieve the desired cooling air velocities on the animals below. Once the specific nozzle is selected, the nozzle characteristics and the number of nozzles can be used to estimate the airflow per nozzle in cubic feet per minute (cfm).

Once the airflow per nozzle is estimated, in the next step (step four in this example), the total airflow through the system can be estimated. To make this determination, first the interior volume of the space to be ventilated is calculated by multiplying the length, the width, and the height of the space (L×W×H) to yield the interior volume in cubic feet. This interior volume is then multiplied by the desired number of air changes per hour and then divided by 60 to get the system airflow (in cubic feet per minute).

Once the total airflow of the system has been estimated, the next step differs depending on whether the system is being used solely to cool the target animals or whether it is being used both to cool animals and ventilate the building. In those embodiments in which the positive-pressure system is being used solely to cool the target animals, the next step (the fifth step) is skipped.

On the other hand, in those implementations in which the positive-pressure system is being used to both ventilate the building and cool the animals, the next step (the fifth step) is to determine whether the plenum delivers the approximate airflow desired for the overall ventilation rate (whether it ventilates the space as desired). For example, a desired ventilation rate could be 30 air changes per hour, 50 per hour, 100 per hour, or the like.

If it is determined that the airflow generated by the system is satisfactory, then it is time to move on to the sixth step. On the other hand, if the system delivers less airflow than desired, then adjustments can be made to increase the airflow. For example, the number of nozzles can be increased, or the nozzles can be increased in diameter and shortened in length. On the other hand, if the plenum system delivers more airflow than desired, similar parameters can be adjusted. For example, the number of nozzles can be reduced or the nozzles can be decreased in diameter and lengthened.

Finally, the size of the cross-sectional area of the plenum is determined. That is, the plenum can be sized to keep the velocity of the airflow within the plenum near the fans to a moderate speed. The standard guidelines are to maintain a velocity that is less than 1,200 ft per minute. As such, the cross-sectional dimension of its width and height (rather than its length) can be set such that the velocity within the plenum is less than 1,200 feet per minute near the fans. Alternatively, or in addition to the plenum dimensions, other parameters can be adjusted as well. For example, in certain embodiments (include some as described elsewhere herein), two fans can be used, with a fan mounted at each end of a plenum, thereby allowing the cross-sectional area to be halved. Alternatively, one or more fans can be mounted along the length of a long plenum to further reduce the required cross-sectional area.

In certain embodiments, the above steps can be used to determine the specific parameters of a cooling system based on the specific dimensions of the target barn. Two specific examples of the method being used are set forth in Examples 2 and 3 below.

According to one specific embodiment, a positive-pressure cooling and ventilation system 16 is incorporated into a milking barn 10 (including, for example, a robot milking barn 10) as best shown in FIGS. 1A (discussed briefly above) and 4A-4G. As best shown in FIG. 4A, the system 16 is made up of 5 plenums 22A-22E as shown, with the two outer plenums 22A, 22E, two inner plenums 22B, 22D, and one central plenum 22C. The outer plenums 22A, 22E have one fan 32 on each end (with the opposite end not visible in FIG. 4A), while the inner plenums 22B, 22D and the central plenum 22C each have two fans 32 on each end. As best shown in FIGS. 4B and 4C, each plenum 22A-22E has distribution tubes 82 extending down from the bottom of the plenum 22A-22E such that each tube 82 directs an air stream vertically toward the animal living space 86 below as described in detail elsewhere herein. More specifically, each tube 82 is disposed such that the vertical air stream discharged therefrom is substantially transverse to the plane of the floor of the barn 10 and is discharged to the area directly below the tube 82. In addition, as best shown in FIGS. 4D and 4E, in certain embodiments, the central plenum 22C (and any other plenum in the system 16) can also have angled distribution tubes 84 extending from the plenum 22C such that the angled tubes 84 generate air streams that are disposed at an angle in comparison to the air streams discharged from the tubes 82. According to one implementation, the angled distribution tubes 84 are aimed downward and away from the center of the plenum 22C such that the air jets are directed to an area that is not directly below the plenum 22C, thereby expanding the range of the air jets being discharged from the plenum 22C (and the related cooling effect) beyond the width of the plenum 22C.

In this implementation, the plenums 22A-22E can be modular plenums 22A-22E similar to the exemplary plenum 50 discussed above such that the number and size of the modular components of each plenum 22A-22E can be determined based on the length and width and any other relevant dimensions of the barn 10 and the components can be easily coupled together to construct the resulting plenums 22A-22E.

The specific exemplary barn 10 as shown has no ceiling separating the roof 80 from the living space 86 below. As such, each plenum 22A-22E is disposed within the barn under the roof 80 and above the living space 86 such that the distribution tubes 82 can direct their airstreams downward onto the animals in the living space 86 at the desired velocities.

As best shown in FIG. 4F, in certain embodiments, the plenums 22A-22E are disposed within the building 10 such that the fans 32 are disposed on both end walls of the building 10 (only one of which is visible in FIG. 4F) as shown. Alternatively, as shown in FIG. 4G, hoods 86 (or any other covering structure) can be attached to or otherwise disposed on the end walls of the building 10 to cover the fans (not shown), thereby providing sufficient cover to prevent rain from being pulled into the plenums 22A-22E as discussed in further detail above.

According to another implementation, a positive-pressure cooling and ventilation system 18 is incorporated into a four-row head-to-head freestall barn 12 as best shown in FIGS. 1B (discussed briefly above) and 5A-5E. As best shown in FIGS. 5A and 5B, the system 18 is made up of two plenums 24A, 24B as shown. Each of the plenums 24A-B has two fans 34 on each end (with the opposite end not visible in the figures).

In this implementation, the plenums 24A-B can be modular plenums 24A-B similar to the exemplary plenums 50 and 22A-22E discussed above such that the number and size of the modular components of each plenum 24A-B can be determined based on the length and width and any other relevant dimensions of the barn 12 and the components can be easily coupled together to construct the resulting plenums 24A-B.

In this exemplary embodiment as best shown in FIG. 5E, each of the plenums 24A-B has a bottom wall 106 with an upper section 106A, a sloped section 106B, and a lower section 106C as shown. That is, the sloped section 106B of the bottom wall 106 is sloped upward such that the upper section 106A coupled to the sloped section 106B is disposed higher above the floor of the barn 12 than the lower section 106C.

Continuing with FIG. 5E, each plenum 24A-B has distribution tubes 100A, 100B extending down from the bottom of the plenum 24A-B such that each tube 100A-B directs an air stream vertically toward the animal living space 102 below as described in detail elsewhere herein. More specifically, there is a plurality of distribution tubes 100A extending from the upper section 106A and a plurality of distribution tubes 1001B extending from the lower section 106C as shown. According to one embodiment as best shown in FIG. 5A, the distribution tubes 100A extending from the upper section 106A are disposed in a single row and positioned above the feeding area 108 of the barn 12, while the distribution tubes 100B extending from the lower section 106C are disposed in rows of 6 and positioned above the stalls 110 in the barn 12.

In this embodiment, the distal ends of all of the tubes 100A, 100B are disposed at the same height above the floor of the barn 12. As discussed in detail above, this ensures that the target air stream velocities at the desired heights above the barn floor are achieved by each tube 100A, 100B, regardless of the variability of the height of the bottom wall 106. As a result, as best shown in FIGS. 5B and 5E, given that the lower section 106C is lower than the upper section 106A, the tubes 100A extending from the lower section 106C are shorter than the tubes 1001B extending from the upper section 106A. According to some specific embodiments, the length that the tubes 100A extend from the lower section 106C can be minimal or zero.

In certain embodiments including the one as shown in FIGS. 5A-5E, the two plenums 24A-B are positioned within the barn 12 such that there is a space therebetween. According to certain embodiments, the space between the plenums 24A-24B provides sufficient space above the feed and manure removal lanes 104 such that the appropriate vehicles can pass therethrough.

Like the previous embodiment in FIGS. 4A-4G, the specific exemplary barn 12 as shown in FIGS. 5A-5E has no ceiling separating the roof 112 from the living space 102 below. As such, both plenums 24A, 24B are disposed within the barn 12 under the roof 112 and above the living space 102 such that the distribution tubes 100A, 100B can direct their air streams downward onto the animals in the living space 102 at the desired velocities as described above.

Further, as best shown in FIGS. 5A-5B, in certain embodiments, the plenums 24A, 24B are disposed within the building 12 such that the fans 34 are disposed on both end walls of the building 12 (only one of which is visible in the figures) as shown. Alternatively, hoods (or any other covering structure) (not shown) similar to those described with respect to the embodiment in FIG. 4G can be attached to or otherwise disposed on the end walls of the building 12 to cover the fans (not shown), thereby providing sufficient cover to prevent rain from being pulled into the plenums 24A, 24B as discussed in further detail above. In a further alternative, the fans 34 can be recessed within the end walls (not shown) to ensure rain doesn't get into the plenums 24A, 24B.

In yet another embodiment, a positive-pressure cooling and ventilation system 20 is incorporated into a traditional tie-stall barn 14 with a high open haymow 120 as best shown in FIGS. 1C (discussed briefly above) and 6A-6D. As best shown in FIGS. 6A and 6B, the system 20 is made up of two plenums 26A, 26B as shown. Each of the plenums 26A-B has one fan 36 on each end (with the opposite end not visible in the figures).

In this implementation, the plenums 26A-B can be modular plenums 26A-B similar to the exemplary plenums 50, 22A-22E, and 24A-B discussed above such that the number and size of the modular components of each plenum 26A-B can be determined based on the length and width and any other relevant dimensions of the barn 14 and the components can be easily coupled together to construct the resulting plenums 26A-B.

In this exemplary embodiment, the two plenums 26A-B are disposed on the floor 122 of the haymow 120 as best shown in FIGS. 6A and 6B. As such, in certain implementations, the floor 122 of the haymow 120 can also serve as the bottom wall 122 of the plenums 26A-26B as best shown in FIG. 6A. Thus, the distribution tubes 124 extend upward some predetermined length into the interior of the plenums 26A-B as shown in FIG. 6A and further extend downward through the ceiling 126 of the barn 14 and some predetermined length into the living space 128 of the barn 14. In certain embodiments, the tubes 124 extend upward into the interior such that the proximal openings are disposed above any insulation within the plenums 26A-B in a fashion similar to other embodiments herein. Further, the distance that the tubes 124 extend from the ceiling 126 is the distance at which the air streams from the tubes 124 achieve their optimal velocities as discussed in detail elsewhere herein.

As best shown in FIG. 6C, the tubes 124 extending from each plenum 26A-26B are disposed in rows as shown, such that the tubes 124 positioned above the target areas of the living space 128. For example, in one embodiment as best shown in FIG. 6A, the tubes 124 are disposed above the stalls 130 such that the animals are cooled while standing or lying in the stalls 130.

Further, as best shown in FIG. 6A, in certain embodiments, the plenums 26A-B are disposed within the building 14 such that the fans 36 are disposed on both end walls of the building 14 (only one of which is visible in the figures) as shown. In certain implementations as best shown in FIG. 6D, hoods 132 (or any other covering structure) can be attached to or otherwise disposed on the end walls of the building 14 to cover the fans 36, thereby providing sufficient cover to prevent rain from being pulled into the plenums 26A-B as discussed in further detail above. In a further alternative, the fans 36 can be recessed within the end walls (not shown) to ensure rain doesn't get into the plenums 26A-B.

A further implementation of a positive-pressure cooling and ventilation system 180 is incorporated into another building 182 as best shown in FIGS. 7A-7C. In this specific embodiment, instead of separate plenum structures similar to the embodiments of FIGS. 1A-6D, the pressurizable space 184 is the attic 184 of the building 182 in a fashion similar to the pressurizable attic/haymow space embodiments discussed above. More specifically, as best shown in FIGS. 7A and 7C, the system 180 is made up of two separate pressurizable attic spaces 184A, 184B with a wall 188 separating the two spaces 184A-B as shown. Each of the pressurizable spaces 184A-B has at least one fan (not shown) covered by a hood 186 at one end of the building 182 as best shown in FIG. 7A.

In this and similar implementations, the entire attic 184 can be pressurized such that the entire space (or two separate spaces 184A-B in this particular embodiment) operates in a fashion substantially similar to any plenum embodiment as discussed herein. In this embodiment, the two pressurizable spaces 184A-B are separated by a wall 188 as shown such that the two spaces 184A-B are separately pressurizable, thereby resulting in the different target areas below the separate spaces 184A-B being separately cooled and/or ventilated. For example, one of the spaces 184A may be disposed over the holding pens 190 while the other space 184B may be disposed over the work room 192. In a further alternative, the attic 184 can be a single pressurizable space or three or more pressurizable spaces.

As discussed above, each of the two pressurizable spaces 184A-B are configured to have an interior that is substantially fluidically sealed from the exterior of the space 184A-B such that the pressurized air cannot escape except through the distribution tubes. As explained in detail above, this can be accomplished via an airtight flexible material added to the interior of the walls of the space 184A-B, construction that is tighter than typical barn construction, a sealant or other barrier, or any other known device, material, or method to establish a substantially airtight seal between the space 184A-B and the exterior thereof.

In this embodiment, the floor 194 of the attic 184 also serves as the ceiling 196 of the living space 198 such that the insulation tubes 200A, 200B extend from the interior of the pressurizable spaces 184A-B, through the floor 194, and downward a predetermined length below the ceiling 196 as shown. Thus, the insulation tubes 200A extend from the first pressurizable space 184A and some length below the ceiling 196 above the holding pens 190, while the insulation tubes 200B extend from the second pressurizable space 184B and some length below the ceiling 196 above the work room 192. Further, the distal ends of all of the tubes 200A-B are disposed at the same height above the floor of the barn 182 to ensure that the target air stream velocities at the desired heights above the barn floor are achieved by each tube 200A-B.

According one embodiment, the system 180 can also include exhaust towers 202 that allow the air urged into the living space 198 via the distribution tubes 200A-B to exit the living space 190. Each tower 202 has an opening 204 defined in the ceiling 196 as best shown in FIG. 7B, an elongate body 206 that extends through the attic 184 and the roof 208, and a cupola 210 or other structure disposed at the top of the elongate body 206 to vent the exhaust air out of the elongate body 206. Alternatively, the exhaust towers 202 can be any known exhaust towers of any configuration. Alternatively, any other known feature, device, or method for exhausting the air from the living space 190 can be used.

In accordance with any of the various system embodiments disclosed or contemplated herein, the fans can be disposed on at least one side of the building instead of, or in addition to, at least one end. More specifically, there may be various reasons to have fans on the sides of the building instead of (or in addition to) the ends, including because the barn has sufficient length such that additional fans are helpful or necessary. Alternatively, the fans may be disposed on the sides of the building because the construction or configuration of the building makes it helpful or necessary to have the fans on the sides (either alone or in combination with fans on the ends). In a further alternative, there may be fans disposed on the sides for any number of reasons.

Yet another embodiment is depicted in FIGS. 8A and 8B, in which the barn 240 has a cooling system 242 having two sets of hoods 244, 246 extending from one side of the barn 240 to the other with fans (not shown) thereunder. In this embodiment, the system 242 has no fans disposed on the ends of the barn 240. Instead, the first set of hoods 244 has a hood 244A on one side and a hood 244B on the other side as shown with at least one fan (not shown) under each of the hoods 244A-B, while the second set of hoods 246 also has a hood 246A on one side and a hood 246B on the other side as shown with at least one fan (not shown) under each of the hoods 246A, 246B. The underside of one hood 244A of the first set 244 is shown in closer detail in FIG. 8B such that a fan 248 disposed under the hood 244A is depicted. According to various embodiments, the system 242 can have one or more plenums or one or more pressurizable spaces disposed within the barn 240 into which the fans (not shown, except for fan 248) urge the fresh outside air in accordance with any of the embodiments depicted and/or discussed herein. Further, the barn 240 and the system 242 can have any of the components and features as disclosed or contemplated with respect to any of the other embodiments herein.

In any of the various cooling system implementations disclosed or contemplated herein, there can be access openings (such as doors or other types of access openings) in any of the plenums and/or pressurizable spaces in order to provide access to the interior thereof for maintenance, repairs, and any other reason. One exemplary opening 249 in a plenum 247 is depicted in FIG. 9. Alternatively, any type of opening of any structure and in any location is contemplated herein. Further, such openings have doors, hatches, or any other type of removable covers (not shown) that can be placed over the openings to re-establish the fluidic seal required for the structures.

According to a further implementation, a modular positive-pressure cooling and ventilation system 250 is incorporated into a barn 252 as best shown in FIG. 10. Three modular plenums 254A-254C are visible in the figure, with each plenum 254A-254C having distribution tubes 256 extending down through the bottom of each plenum 22A-22E such that each tube 256 directs an air stream vertically toward the animal living space 258 below as described in detail in various embodiments elsewhere herein. In this implementation, the modular plenums 254A-254C are similar to the exemplary plenum 50 discussed above such that the number and size of the modular components of each plenum 254A-254C can be determined based on the length and width and any other relevant dimensions of the barn 252 and the components can be easily coupled together to construct the resulting plenums 254A-254C, as will be discussed in additional detail below. Except as discussed in detail below, these plenums 254A-254C and the system 250 can be substantially similar to any of the other plenum embodiments disclosed or contemplated herein and can have any of the various components and features thereof. For example, each plenum 254A-254C can have one or more fans (not shown) on each end thereof.

One exemplary modular plenum section 260 of the plenums 254A-254C is depicted in further detail in FIGS. 11A and 11B, according to one embodiment. Alternatively, the modular section 260 can have any configuration and thus can be incorporated into any of the various cooling system embodiments disclosed or contemplated herein. The plenum section 260 has a base or bottom panel 262 through which the distribution tubes 256 are disposed, two side panels 264A, 264B, and a top panel or cover 266. In addition, it is noted that each of the two plenum sections 260 disposed at the opposing ends of the plenum (such as plenum 254A, 254B, or 254C) installed in the barn 252 have end panels (not shown) attached thereto, each of which may have one or more fans incorporated therein, as is described with respect to the all of the various different plenum embodiments disclosed or contemplated herein.

Each of the panels 262, 264A-B, 266 (and the end panels) are easily attachable to and detachable from the corresponding panels for quick and efficient construction of each section 260 and the full plenums 254A-C of the system 250. As best shown in FIG. 11B, the base panel 262 can have side walls 268A, 268B to which the side panels 264A-B can easily attach. For example, in the exemplary embodiment as shown, each side panel 264A-B has an elongate slot 270 along the bottom edge of the panel 264A-B that is sized and shaped to receive a side wall 268A-B therein such that the side panels 264A-B can be slidably attached to the base panel 262 as shown. Alternatively, any known mechanisms, components, or features can be used for attachment of the side panels 264A-B to the base panel 262 in a similar fashion. In addition, the top panel 266 can be attached to the side panels 264A-B via screws, bolts, or any other known fasteners or mechanisms. Further, the sections 260 can be attached to each other via screws, bolts, or other fasteners or mechanisms inserted through openings 272 defined in the ends of the sections 260 as shown. Alternatively, any other known attachment mechanism, features, or components can be used.

Because of the modular nature of each section 260, the various panels 262, 264A-B, 266 (and the end panels) can be available in certain different predetermined sizes, thereby resulting in sections 260 (and thus plenums 254A-C) of certain different predetermined sizes/dimensions. Thus, each section 260 can come in two, three, four, five, six, seven, eight, nine, ten, or any other number of different sizes as a result of the various panels 262, 264A-B, 266 coming in different sizes. Further, instead of varying the dimensions of the components, the number of components can also vary in certain situations. For example, the number of side panels 264A-B incorporated into each side of a particular section 260 can vary depending on the desired dimensions of the section 260 and thus the plenum (such as any of plenums 254A-C). Thus, as shown in FIG. 11B, each side of the section 260 can be made up of one side panel 264A, 264B, or, alternatively, can have two side panels 264A-1 as shown on the left side of FIG. 11B. In a further alternative, each section 260 can have any number of side panels 264A, 264B on each side as needed for the desired dimensions.

Any of the various plenum and system embodiments disclosed or contemplated herein can also be modular in a similar fashion and can have similar panels (similar to panels 262, 264A-B, 266, and the end panels) that can vary in size in a similar fashion, thereby resulting in any of the various systems herein being modular and being available in various sizes.

All of the various embodiments disclosed or contemplated herein provide a different approach to animal building cooling and ventilation. More specifically, every implementation uses positive pressure in a plenum or other pressurizable space to provide cooling air speeds to every individual animal in the living space of the building. The air reaching each animal is fresh air and that has not passed over or past any other animals. Further, the various systems disclosed or contemplated herein provide that the fresh air enters all of the target spaces of the entire building in a uniform fashion (including uniform velocities), thereby resulting in an equivalent temperature across most or substantially all of the animal space. In addition, because the fans are moving fresh air from the outside instead of pulling dirty air from the building, the fans remain much cleaner and require far less cleaning and maintenance. Also, in all of the system embodiments herein, the animal living space is not pressurized (as required with the known cooling systems described above), and thus the external doors of the building can be opened at any time for any length of time for normal day-to-day operation, such as equipment usage, without disruption of airflow. Further, the various system implementations herein require lower total air flows than the known cross-ventilated and tunnel systems discussed above such that the systems described herein operate with fewer fans and with significant reductions in electrical demands, thereby reducing operational costs. In addition, the placement of the fans in or adjacent to the roof or ceiling in the various system implementations herein (instead of the walls of the living space itself as required with the known ventilation systems) results in the reduction of noise from the fans in the areas where the animals and works spend significant time. Also, any and all of the various system implementations herein are scalable to be incorporated or retrofitted into small, intermediate, and large-sized facilities.

### Example 1

In Example 1, the impact of the inner diameter of the distribution tube has on the distance at which the air stream from the tube achieves the target velocities of 400 fpm and 200 fpm is examined. These calculations are based on the performance expected from positive-pressure fabric tubes at the stated tube conditions (Wells & Amos, 1993). For example, as shown in Table 2 below, the air jet emerging from a 4-inch diameter hole will dissipate to a velocity of about 400 ft/min at 4.3 ft from the distal end of the tube and to a velocity of about 200 ft/min at 8.5 ft from the distal end of the tube.

TABLE 2

| PVC pipe or | | Throw distance to target | |
|---|---|---|---|
| discharge hole | Cfm per air jet | air velocity, feet | |
| Internal diameter, in | cfm | 400 fpm | 200 fpm |
| 3 | 60 | 3.2 | 6.4 |
| 3.5 | 80 | 3.7 | 7.4 |
| 4 | 105 | 4.3 | 8.5 |
| 5 | 165 | 5.3 | 10.6 |
| 6 | 240 | 6.4 | 12.8 |
| 8 | 420 | 8.5 | 17.0 |

Values simulated using Positive Pressure Tube Calculator 6.0.4.xlsm and values for a tube receiving 10,000 cfm with a SP = 0.18, DisCoeff = 0.68, and Aperture ration = 1.0. Effective discharge speed estimated at 1,687 ft/min.

Using this information, any cooling system embodiment disclosed or contemplated herein can be incorporated into any barn to produce the desired amount of air stream velocity via precise modification of the other parameters of the system. More specifically, the specific dimensions of any barn can be taken into account to incorporate a cooling system therein that achieves the desired airstream velocities delivered by each distribution tube, and the various system embodiments herein further allow for the various components therein to have one of a variety of different configurations (with different dimensions) to achieve those velocities.

For example, the specific exemplary barn dimensions discussed above with respect to FIG. 3 can be used in combination with the information from Table 2 above to achieve the target velocities using distribution tubes 62 of varying dimensions. More specifically, based on Table 2, air distribution tubes 62 having a 6-inch internal diameter and no length extending below the ceiling can be incorporated into the barn of FIG. 3 and thereby deliver air velocities of about 400 feet/min at 6.4 feet below the ceiling 54 (or 5.6 feet above the floor 52) and about 5 feet above the freestall bed surface 72. Further, air velocities exceeding 200 feet/min would be expected at the floor 52 of the barn. Alternatively, the tubes 62 can have a 4-inch diameter and extend 2.0 feet below the ceiling 54 and achieve the same velocities. Another alternative would be 5-inch diameter distribution tubes 62 extending approximately 1 foot below the ceiling 54.

### Example 2

In Example 2, one specific method of building a cooling system with the desired air stream velocity based on the specific dimensions of the target area is shown. For this example, the pen or area to be cooled and ventilated is a compost-barn bedded pack that is 300 feet long, 40 feet wide, and 12 feet high, with a feeding fence and apron that are 14 feet wide, while the bedded pack is 26 feet wide.

As set forth in Table 2, the air jets from the 5-inch diameter distribution tubes should deliver 400 feet/min speeds at 5.3 feet and 200 feet/min at 10.6 feet from the nozzle. Relative to the feeding floor, 400 feet/m would be found at 6.7 feet high and 200 feet/m at 1.4 feet high. If the bedded pack is 1 foot thick, the tops of cows lying on the pack would be about 3.5 feet above the feeding floor and air speeds should be approximately 275 feet/min. These speeds would be expected with no extension of the distribution tubes below the ceiling and would be appropriate for adequate cooling of the animals in hot weather.

Assuming the jets expand at a 22° angle, each jet should have diameter of about 4.5 feet on the surface of the bedded pack, 11 feet from the ceiling. If the nozzles were spaced at intervals of 4.0 feet on center, approximately 90% of the bedded pack surface would be touched directly by the air jets with a velocity of about 150 feet/min. This is judged to be adequate coverage of the resting animals.

For this cooling system, it is proposed to have one air jet every 4 feet apart over the pack and two air jets over cows eating and spaced every 4 feet along the length of the pen. Thus, there would be rows of 8 air jets (6 over the pack and 2 over the feeding area) every four feet. Given that there are 74 rows of these 8 air jets, the total number of distribution tubes required is 592 tubes. Assuming 165 cfm of air through each 5-inch nozzle, the system would deliver 97,680 cfm throughout the pen.

The pen, including the bedded pack and feeding area, has a volume of 144,000 cubic feet. The estimated maximum airflow from the ventilation system would be 97,680 cfm, which would provide 40.7 air changes per hour (ACH). This rate of ventilation is well within traditional maximum recommendations for ventilation of livestock buildings in warm and hot weather.

Thus, it can be concluded based on these results that the air jet velocities are sufficient to provide the necessary cooling to the animals in the living space and adequate ventilation of the surrounding barn.

### Example 3

In Example 3, the method of Example 2 is used to create a cooling system with the desired air stream velocity in a freestall barn. For this example, the base dimensions remain the same as the previous example, with the pen or area to be cooled and ventilated is 300 feet long, 40 feet wide, and 12 feet high, resulting in a volume of 144,000 cubic feet.

In a freestall barn with 2-row head-to-head stalls, the 300′×40′×12′ pen has 122 cow individual stalls in two rows in a head-to-head arrangement. The base of the freestalls is 18 feet wide. Like the barn in Example 2, it has a feeding fence and a 14′ feeding apron. Because cows spend ~95% of their pen time lying in the freestalls or eating at the feeding fence, nozzles for cooling air jets will be placed over the freestalls and feeding area only and will not be distributed over the traffic lanes in the pen.

Because the nozzles will be distributed over a smaller area in this Example 3, it is proposed that 5 distribution tubes be placed above each pair of stalls approximately 3 ft apart, and two over the feeding area, again 3 ft apart. Because the nozzles are closer together, the air jets can be smaller and still provide cooling coverage. If we choose 4-inch diameter nozzles and extend them 2 feet from the plenum above, each nozzle would deliver 105 cfm with a velocity of approximately 400 ft per minute on the backs of cows standing at the feeding fence and well over 200 ft per minute on the backs of cows lying in freestalls, adequate for animal cooling.

With 7 nozzles in each row, the rows of tubes would be spaced at 4 feet intervals across the length of the barn, resulting in 74 rows of 7 air jets, yielding a total of 518 distribution tubes. The 4-inch diameter nozzles, each delivering 105 cfm, would provide 54,390 cfm to the entire pen and provide an air exchange rate for the entire pen of 22.6 air changes per hour. While the air jets would provide cooling of the individual animals, the overall air exchange rate is generally viewed as insufficient for hot weather, allowing the building to accumulate heat.

Other configurations of 4-inch tubes could be considered, such as 5 tubes over each freestall and 2 at each 4 feet interval adjacent to the feed lane. Each nozzle would project 2 feet from the plenum above. This would yield 12 tubes every 4 feet to total 924 tubes and would deliver about 40 ACH.

So, an alternative layout is proposed. In this configuration, 6 distribution tubes are provided over each pair of stalls (3 per stall) and two more nozzles over the feeding apron, and each tube being 5-inches in diameter, with no extension beyond the plenum. Each row of 8 nozzles would be spaced every four feet, yielding 97,680 cfm or 40.7 air changes per hour (ACH). While the density of air jets over the 18-feet wide freestall area being substantially greater than the density over the 26-feet wide bedded pack in Example 2, the overall ventilation rate of the building is the same as Example 2 at 40.7 ACH.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1%, and 4% This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A modular plenum for a positive pressure cooling and/or ventilation system, the plenum comprising:
(a) a bottom wall, a top wall, two side walls, and two end walls defining an interior within the plenum;
(b) at least two distribution tubes extending through the bottom wall from the interior to an area exterior to the plenum; and
(c) at least one fan disposed in at least one of the end walls, wherein the at least one fan is configured to urge air into the interior of the plenum,
wherein the modular plenum further comprises at least two modular sections that are coupleable with each other to form the modular plenum.

2. The modular plenum of claim 1, wherein the at least one fan is further configured to urge air out of the interior of the plenum through the at least two distribution tubes.

3. The modular plenum of claim 1, wherein the at least two modular sections comprise:
(a) a first modular section comprising at least one of the at least two distribution tubes; and
(b) a second modular section comprising at least one of the at least two distribution tubes.

4. The modular plenum of claim 1, wherein a distal end of each of the at least two distribution tubes is disposed about 10 feet above a floor below the modular plenum.

5. The modular plenum of claim 1, wherein air is urged out of the interior of the plenum through each of the at least two distribution tubes such that the air has a velocity of about 400 feet per minute at a location disposed about 5.7 feet above a floor below the modular plenum.

6. The modular plenum of claim 5, wherein air is urged out of the interior of the plenum through each of the at least two distribution tubes such that the air has a velocity of about 200 feet per minute at a location disposed about 1.5 to about 2 feet above the floor.

7. A modular plenum for a cooling and/or ventilation system for an animal building, the plenum comprising:
(a) an elongate plenum body made up of at least two coupleable sections, the elongate plenum body comprising:
(i) a bottom wall, a top wall, two side walls, and two end walls defining an interior within the elongate plenum body; and
(ii) at least two distribution tubes extending through the bottom wall from the interior to an area exterior to the plenum body; and
(b) at least one fan disposed in at least one of the end walls, wherein the at least one fan is configured to urge air into the interior of the elongate plenum body,

8. The modular plenum of claim 7, wherein the elongate plenum body is disposed beneath a roof of the animal building such that the bottom wall is disposed at a predetermined distance above a floor of the animal building.

9. The modular plenum of claim 7, wherein the elongate plenum body is disposed above a ceiling of the animal building, wherein the at least two distribution tubes extend through the ceiling such that a distal end of each of the at least two distribution tubes is disposed below the ceiling.

10. The modular plenum of claim 7, wherein a distal end of each of the at least two distribution tubes is disposed about 10 feet above a floor of the animal building.

11. The modular plenum of claim 7, wherein air is urged through each of the at least two distribution tubes such that the air has a velocity of about 400 feet per minute at a location disposed about 5.7 feet above a floor of the animal building.

12. The modular plenum of claim 11, wherein air is urged through each of the at least two distribution tubes such that the air has a velocity of about 200 feet per minute at a location disposed about 1.5 to about 2 feet above the floor of the animal building.

13. A cooling and/or ventilation system for an animal building, the system comprising:
(a) at least one elongate modular plenum body made up of at least two coupleable sections, the elongate modular plenum body comprising a bottom wall, a top wall, two side walls, and two end walls defining an interior within the elongate modular plenum body;
(b) at least two distribution tubes extending through the bottom wall of the at least one elongate modular plenum body from the interior to an area exterior to the plenum body; and
(c) at least one fan disposed in at least one of the end walls of the at least one elongate modular plenum body,
wherein the at least one elongate modular plenum body is disposed beneath a roof of the animal building such that the bottom wall is disposed at a predetermined distance above a floor of the animal building.

14. The system of claim 13, wherein the elongate plenum body is disposed above a ceiling of the animal building, wherein the at least two distribution tubes extend through the ceiling such that a distal end of each of the at least two distribution tubes is disposed below the ceiling.

15. The system of claim 13, wherein the bottom wall has greater rigidity than the two side walls.

16. The system of claim 13, wherein the at least two distribution tubes are disposed solely over the animal living spaces of the animal building.

17. The system of claim 13, wherein the at least one fan comprises a first fan disposed in a first of the two end walls and a second fan disposed in a second of the two end walls.

18. The system of claim 13, wherein air is urged through each of the at least two distribution tubes such that the air has a velocity of about 400 feet per minute at a location disposed about 5.7 feet above a floor of the animal building.

19. The system of claim 13, wherein a length of the elongate modular plenum body is substantially parallel to a length of the animal building, wherein the at least one fan is disposed at an end of the animal building.

20. The system of claim 13, wherein a length of the elongate modular plenum body is substantially parallel to a width of the animal building, wherein the at least one fan is disposed along a side of the animal building.
